(19) United States
(12) Patent Application Publication
(10) Pub. No.: US 2012/0206921 A1
(43) Pub. Date: Aug. 16, 2012

(54) LED LAMP ELECTRODE STRUCTURE

(76) Inventors: Kun-Jung CHANG, Kaohsiung City (TW); Ching-Yuan JUAN, Kaohsiung City (TW); Kuo-Chun LIN, Kaohsiung City (TW); Ching-Huang Juan, Kaohsiung City (TW)

(21) Appl. No.: 13/453,341

(22) Filed: Apr. 23, 2012

Related U.S. Application Data
(63) Continuation-in-part of application No. 12/558,228, filed on Sep. 11, 2009.

(51) Int. Cl. F21V 5/04

(52) U.S. Cl. 362/311.02

(57) ABSTRACT

An LED lamp electrode structure aims to clamp an LED chip on the top end of a socket which has two electrode passages running therethrough. The electrode passages hold conductive media which have upper ends soldered to two electrodes of the LED chip to form electric connection and lower ends extended outside the bottom of the socket. The socket has a first thread portion at the lower side running through a holder which has a second thread portion to engage with a lens covering the LED chip. The conductive media are concealed inside the LED lamp. The LED lamp thus formed can be assembled and disassembled easily, and is safer and more aesthetic appealing.

This application is a continuation-in-part, and claims priority, of from U.S. patent application Ser. No. 12/558,228 filed on Sep. 11, 2009, entitled “LED LAMP ELECTRODE STRUCTURE”, the entire contents of which are hereby incorporated by reference.

### FIELD OF THE INVENTION

The present invention relates to an LED lamp and particularly to an LED lamp electrode structure that is assembled rapidly.

### BACKGROUND OF THE INVENTION

Please refer to FIG. 1, conventional LED lamps 1a and 1b have respectively an LED chip 11a or 11b and a heat sink 20a at the bottom of the LED chip 11a or 11b, and an electrode 12a or 12b at an outer side of the LED lamp 1a or 1b. When the LED lamps 1a and 1b are in use for illumination, heat is transmitted via the heat sink 20a to lower the temperature of the LED lamps 1a and 1b.

To facilitate wiring and replacement of the LED lamps 1a and 1b, wiring is done on a printed circuit board 3a in a modular manner with the heat sink 20a located thereon, and then the LED lamps 1a and 1b are soldered on the printed circuit board 3a to become a module. Such a modular structure has drawbacks, notably:

1. Individual LED lamp cannot be changed on the LED lamp module that results in waste of resources.

2. The printed circuit board is formed in a definite shape, direction and layout, such that the LED lamps cannot be configured flexibly on the printed circuit board.

3. The wiring of the printed circuit board is exposed, hence is not aesthetic appealing and also has electrical safety concern.

### SUMMARY OF THE INVENTION

The primary object of the present invention is to overcome the disadvantages of the conventional LED lamp that has electrodes at two sides to result in inflexible configuration of the LED lamp and exposed wiring of the printed circuit board that are inconvenient in use and create safety concern.

To achieve the foregoing object, the invention provide an LED lamp electrode structure that has the electrodes moved from two sides of a conventional LED lamp to the bottom end of the LED lamp of the invention so that the LED lamp can directly connect to conductive wires or a power source to emit light without a printed circuit board, and the LED lamp also can be changed and replaced individually.

The present invention is an improvement based on a U.S. patent application Ser. No. 11/907,279 submitted previously by the Applicant. The present invention provides an LED lamp with an LED chip securely held on the top end of a socket. The socket has two electrode passages running therethrough. Each electrode passage holds a conductive medium, and the conductive medium has an upper end soldered to one electrode of the LED chip to form electric connection and a lower end extended outside the bottom of the socket. The socket has a first thread portion at a lower side to run through a holder. The holder has a second thread portion to engage with a lens covering the LED chip by screwing.

In one embodiment the lens outside the LED chip encases a lamp cup which has a fourth thread portion extended from the bottom end thereof to screw with the second thread portion of the holder. The lamp cup also has a fifth thread portion from an inner rim of the top end thereof to screw with a third thread portion of the lens so that the lens can be directly coupled on the lamp cup.

In one aspect the LED lamp further includes a fastening nut corresponding to the first thread portion.

In another aspect the LED lamp further includes a holding plate which has an opening and two elastic reeds at two sides thereof.

By means of the features set forth above, the invention provides many advantages, notably:

1. The electrodes of the LED lamp are concealed inside the socket and the wiring is also hidden, therefore aesthetic appeal and safety improve.

2. The electrodes of the LED lamp is hidden at the bottom of the socket, hence configuration of the LED lamp is more flexible.

3. The invention provides an LED module to include only a single LED lamp, thus the LED lamp can be changed and replaced individually and also maintain the convenience of modularization.

4. The invention provides optical textures as desired to generate specific light projection shapes and illumination.

5. The socket and holder of the invention are made of high thermal conductive metal and can rapidly conduct heat to the object without adding extra heat sinks.

6. The invention employs a fastening nut or holding plate to directly fasten to the object without additionally tapping the object first.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional LED lamp.

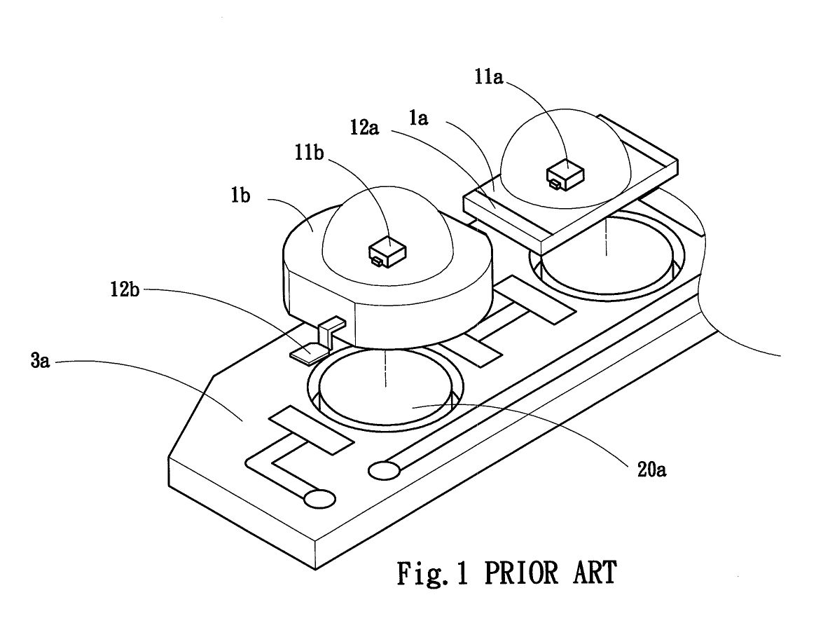

FIG. 2 is an exploded view of the invention.

FIG. 3 is a sectional view according to FIG. 2 in an assembly condition.

FIG. 4 is a front view of a first embodiment of the invention.

FIG. 5 is an exploded view of a second embodiment of the invention.

FIG. 6 is a sectional view according to FIG. 5.

FIG. 7 is an exploded view of a third embodiment of the invention.

FIG. 8 is a front view according to FIG. 7 in an assembly condition.

FIG. 9 is a bottom perspective view of a fourth embodiment of the invention.

FIG. 10 is a sectional view according to FIG. 9.

FIG. 11 is an exploded view according to FIG. 9.

FIG. 12 is an exploded view of another embodiment of the lens of the invention.

FIG. 13 is a sectional view of the fifth embodiment of the invention.

FIG. 14 is a front view according to FIG. 13.

FIG. 15 is an exploded view of another embodiment of the invention.

### DETAILED DESCRIPTION OF THE PREFERRED EMBODIMENTS

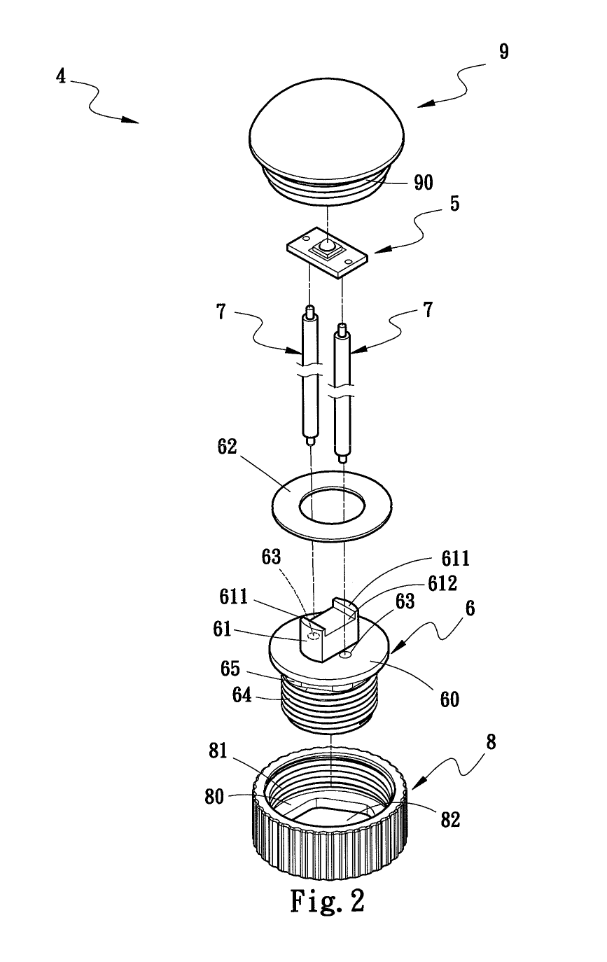

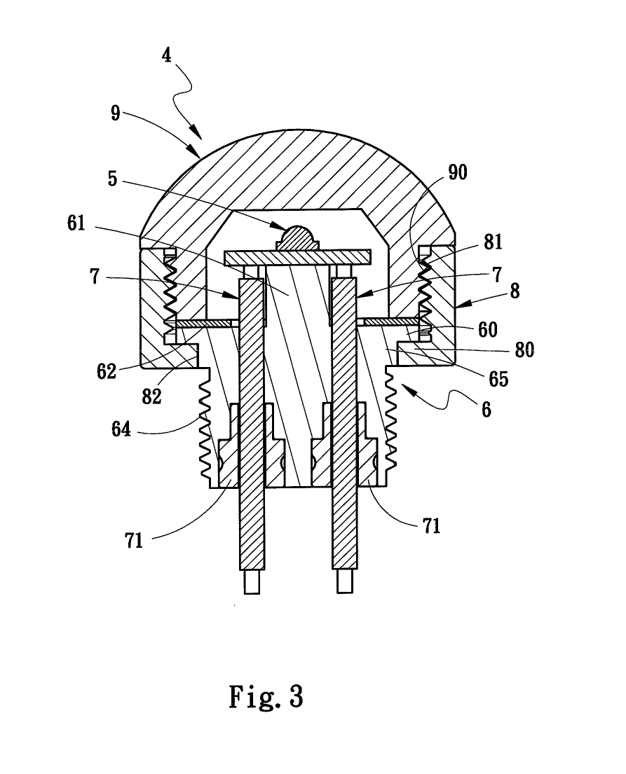

Please refer to FIGS. 2 and 3, the present invention aims to provide an LED lamp electrode structure with an LED lamp 4 which comprises an LED chip 5, a socket 6, two conductive media 7 (can be two conductive wires in embodiments discussed later), a holder 8 and a lens 9. The LED chip 5 has two electrodes (not shown in the drawings). The socket 6 has a base 60 with a clamp portion 61 at an upper side. The clamp portion 61 has two corresponding clamp heads 611 at an upper side and a holding space 612 between the two clamp heads 611 to hold the LED chip 5 clamped by the clamp heads 611. The base 60 further is coupled with a waterproof washer 62, and has two electrode passages 63 running through the socket 6 and holding the conductive media 7 which have upper ends soldered to the two electrodes (not shown in the drawings) of the LED chip 5 to form electric connection and lower ends extended outside the bottom of the socket 6. Each conductive medium 7 is coupled by a waterproof bolt 71 that is held at the bottom of the socket 6. Through the waterproof washer 62 and waterproof bolts 71, the LED lamp electrode structure of the invention can achieve waterproof and airtight effect. The socket 6 further has a hexagonal coupler 65 and a first thread portion 64 extended from the bottom end thereof.

The holder 8 has a hexagonal opening 82 at the bottom run through by the socket 6. The hexagonal opening 82 can be coupled with the hexagonal coupler 65 to form secure positioning without turning loose. The holder 8 also has a retaining portion 80 at the inner bottom end to butt the base 60. The holder 8 has a second thread portion 81 formed on a circumferential inner wall. The socket 6 and holder 8 are made of high thermal conductive metal, such as copper, aluminum or the like to facilitate rapid heat conduction that is generated by the LED chip 5.

The lens 9 has a third thread portion 90 extended from the bottom thereof to screw with the second thread portion 81 of the holder 8. The lens 9 can have optical textures (not shown in the drawings) formed thereon to provide various light projection shapes, such as focus, polarization, pattern projection or the like.

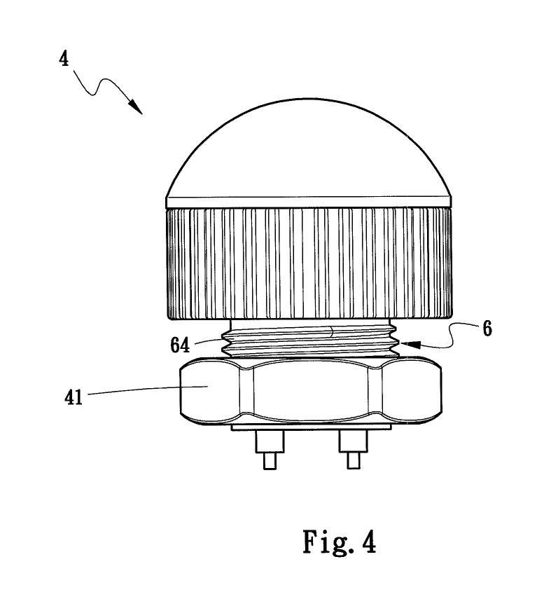

Please refer to FIG. 4 for a first embodiment of the invention in which the LED lamp 4 further includes a fastening nut 41 corresponding to the first thread portion 64 of the socket 6, thereby the LED lamp 4 can be arbitrarily positioned on any location that is suitable for boring to facilitate assembly and disassembly to improve usability and practicality.

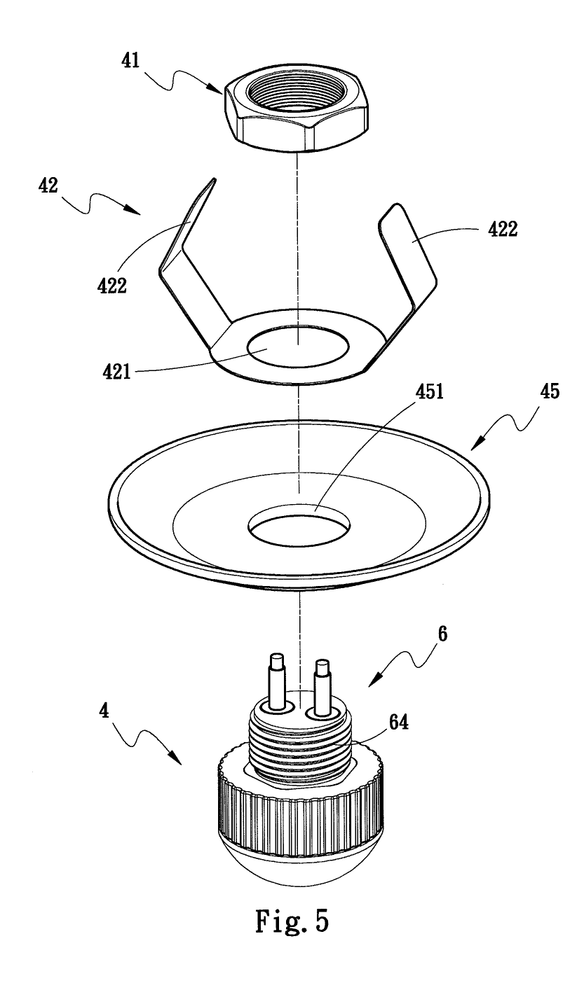

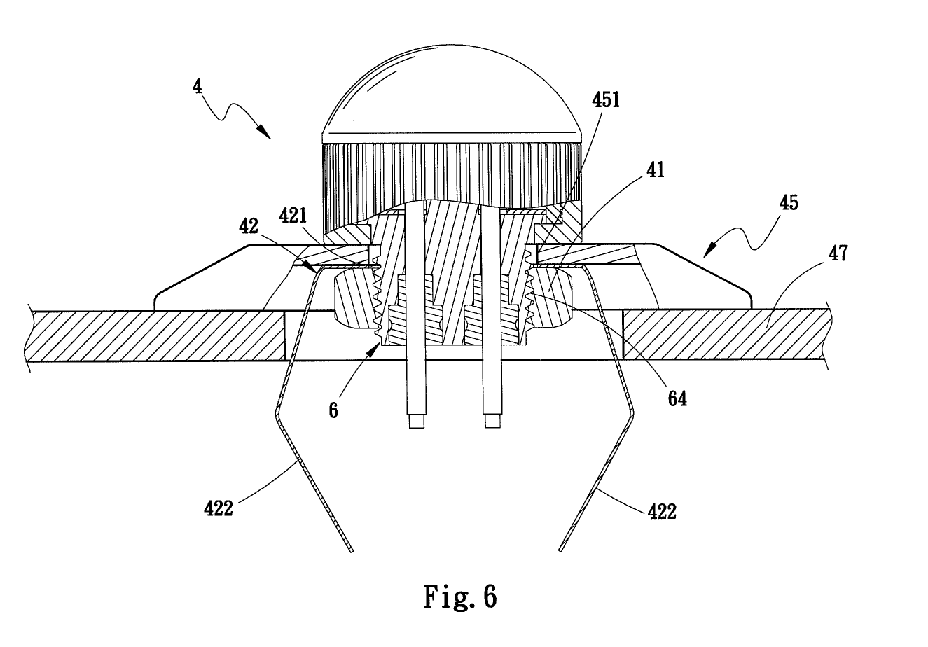

Please refer to FIGS. 5 and 6 for a second embodiment of the invention. The LED lamp 4, aside from containing a fastening nut 41, also has a holding plate 42 and a lamp cap 45. The holding plate 42 has an opening 421 coupled with the first thread portion 64 at the bottom of the socket 6 and two corresponding elastic reeds 422 extended from two sides corresponding to each other. The lamp cap 45 has a hole 451 running through the first thread portion 64 of the socket 6. Thereby the hole 451 and opening 421 can be coupled at the lower side of the socket 6 and fastened via the fastening nut 41 to the first thread portion 64 with the outward tension of the elastic reeds 422 to form secure clamping to facilitate assembly and disassembly to improve practicality. The lamp cap 45 provides enhanced aesthetic appeal when installed on a ceiling 47.

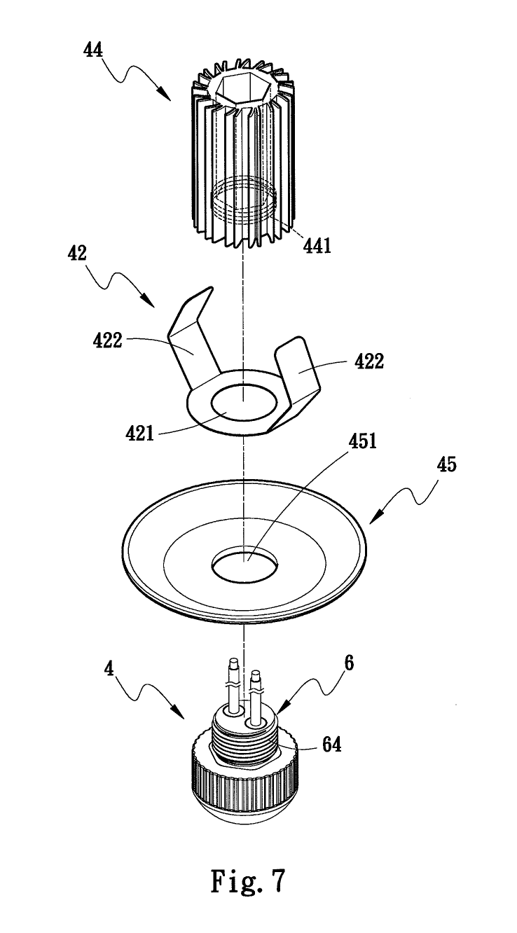

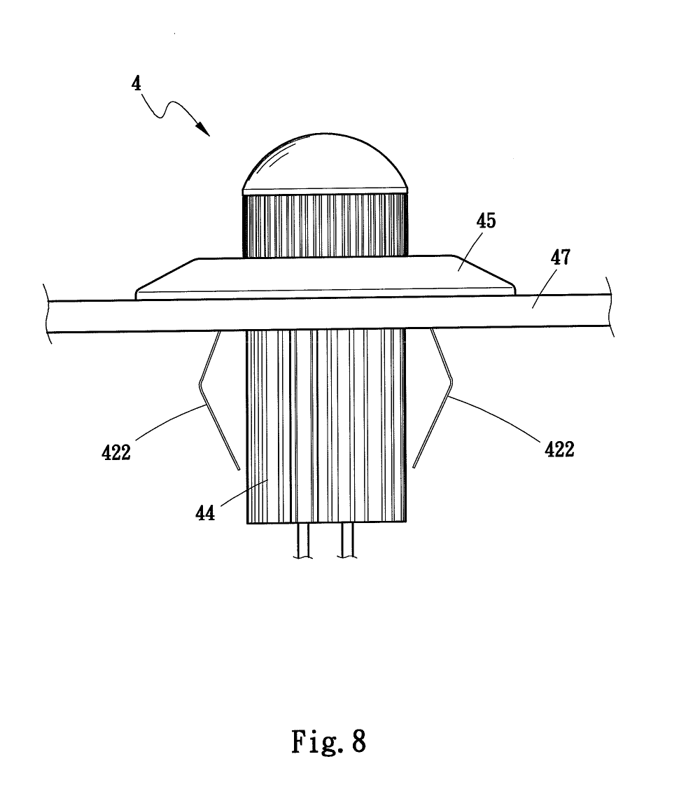

Please refer to FIGS. 7 and 8 for a third embodiment of the invention. The LED lamp 4, aside from the holding plate 42 and lamp cap 45 previously discussed, further has radiation fins 44 with an internal screw hole 441 to couple with the hole 451 of the lamp cap 45 and opening 421 of the holding plate 42 at the lower side of the socket 6, and also installed on the ceiling 47. The internal screw hole 441 can be engaged with the first thread portion 64, thereby to improve cooling of the LED lamp 4.

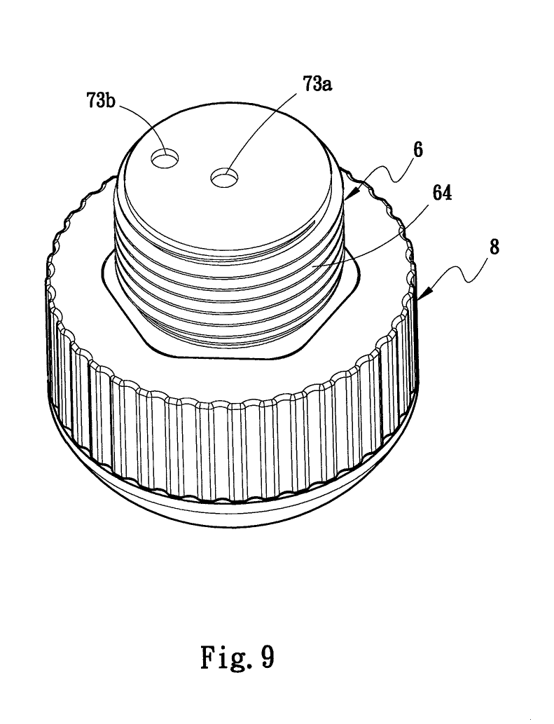

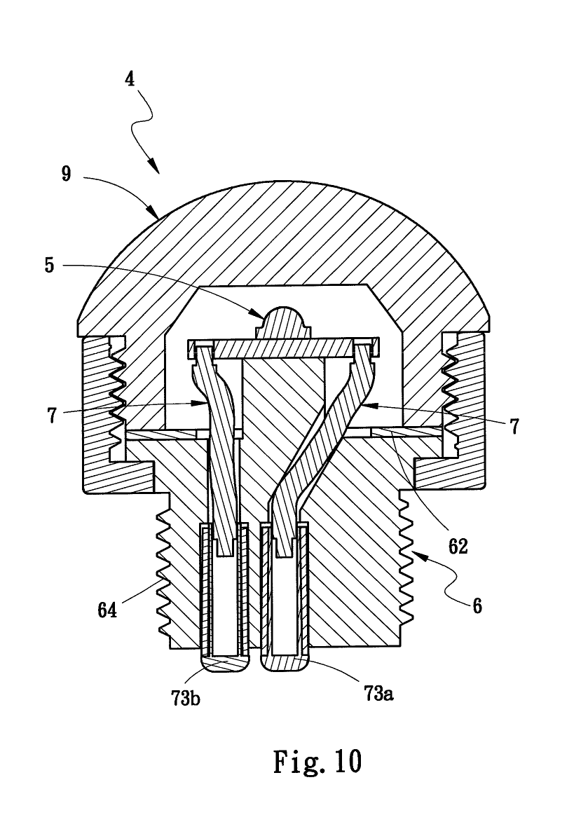

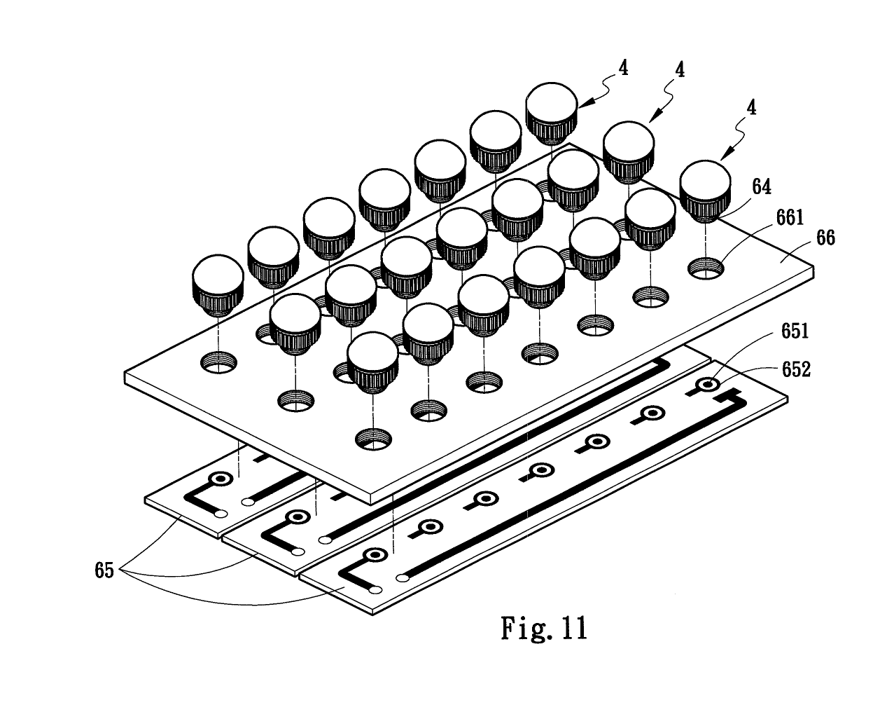

Please refer to FIGS. 9, 10 and 11 for a fourth embodiment of the invention. It is constructed substantially the same as the embodiment in FIGS. 2 and 3, but differs by extending the lower ends of the conductive media 7 outside the bottom of the socket 6 to form two electrode contacts 73a and 73b. One electrode contact 73a is located in the center of the bottom of the socket 6, while another electrode contact 73b is located near the center of the bottom of the socket 6. For installation, the socket 6 is coupled on a printed circuit board 65 via the first thread portion 64, and the printed circuit board 65 has a first contact 651 corresponding to the electrode contact 73a and a second contact 652 corresponding to another electrode contact 73b. The first contact 651 and second contact 652 are concentric circles. Hence a plurality of LED lamps 4 can be coupled on multiple screw holes 661 formed on a socket board 66, while the another electrode contact 73b can be rotated about the electrode contact 73a serving as the center to form electric conduction to the socket. Such a structure also makes installation and disassembly easier.

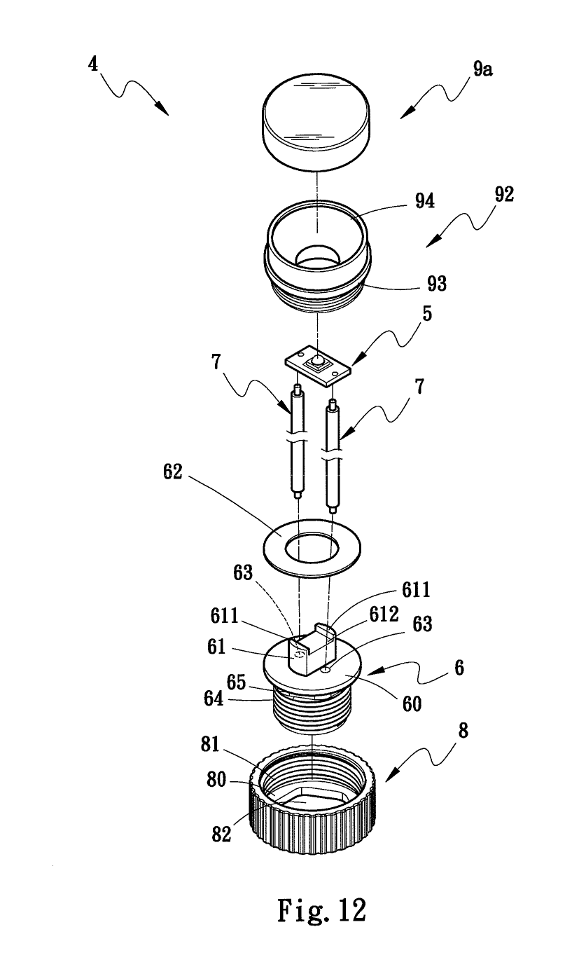

Please refer to FIG. 12 for another embodiment of the lens 9 which is formed in a lamp cup 92. The lamp cup 92 has a fourth thread portion 93 extended from the bottom end thereof to engage with the second thread portion 81 and a fifth thread portion 94 on an inner rim at the top end thereof to engage with the third thread portion 90 of the lens 9 (also referring to FIG. 2). Another approach is to couple a lens 9a directly on the lamp cup 92, and the inner rim of the lens 9a may also have optical textures (not shown in the drawings) formed thereon according to requirements to provide multiple optical projection paths.

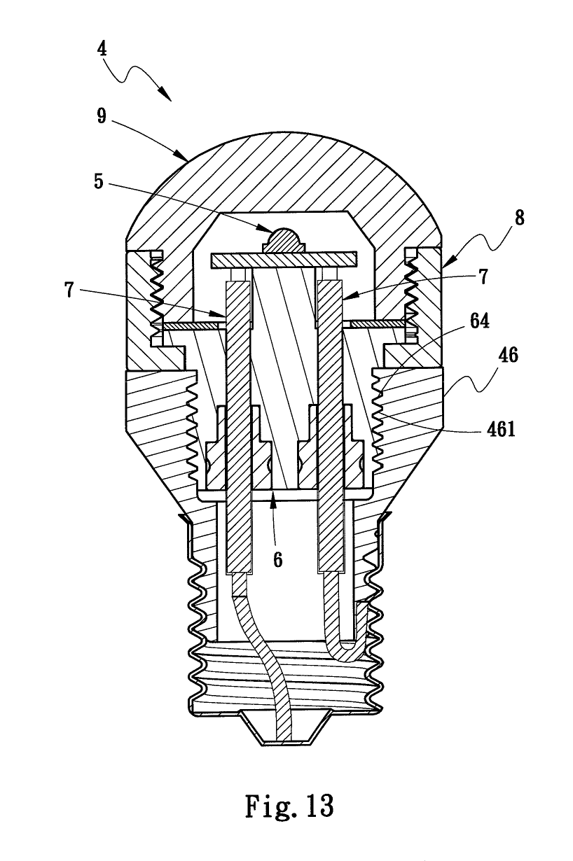

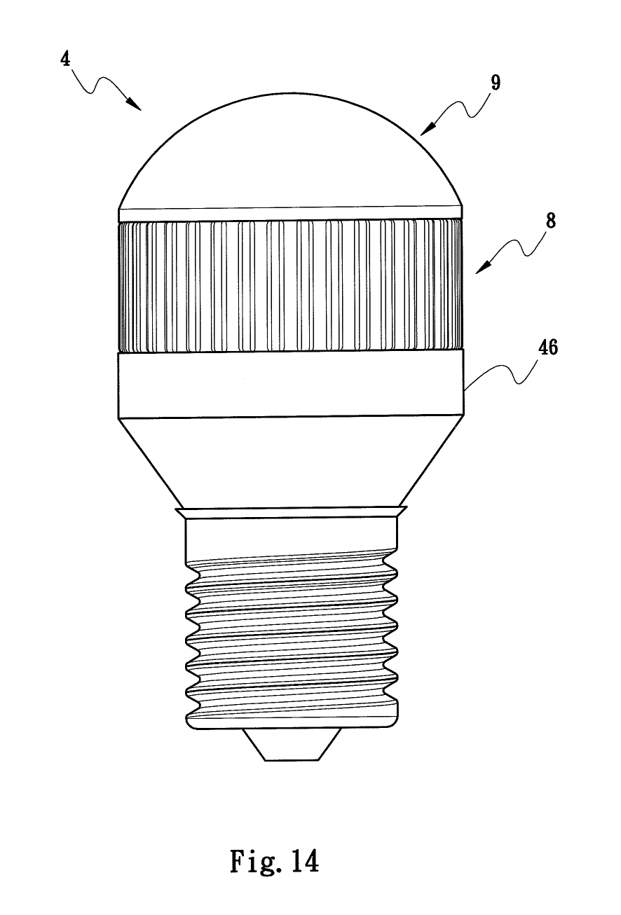

Please refer to FIGS. 13 and 14 for a fifth embodiment. It is like the embodiment shown in FIG. 3 but with a sixth thread portion 461 formed on a lamp shell 46 to engage with the first thread portion 64. The lamp shell 46 is formed in a profile of a light bulb with the two conductive media 7 extended to one side and bottom of the lamp shell 46. Such a structure makes the invention adoptable to the traditional lighting fixtures to increase applicability of the invention.

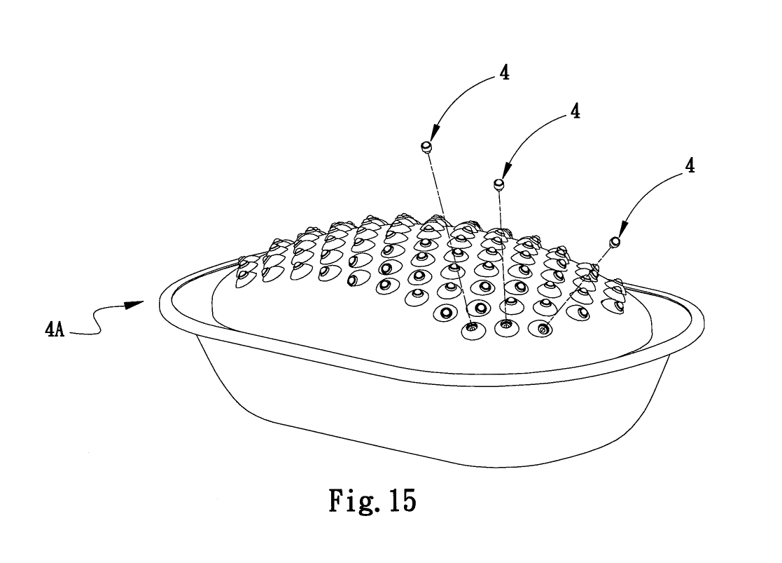

Please refer to FIG. 15 for another embodiment of the invention. The LED lamp 4 is fastened to a cooling seat 4A with an irregular arched surface which can be formed in any profile as desired to function as a lamp shell of a lighting fixture. Such a structure not only can conceal wiring, the LED lamp 4 also can be mounted onto the arched cooling seat 4A in varying directions and angles to provide special lighting requirements. Moreover, the lamp shell also can function as a heat sink to disperse heat generated by the LED lamp 4.

What is claimed is:

1. An LED lamp electrode structure, comprising:
an LED chip including two electrodes;
a socket including a base which includes a clamp portion at the top, two electrode passages running through the socket and a waterproof washer coupled thereon, the clamp portion including two clamp heads on an upper side to clamp the LED chip, the socket further including a first thread portion extended from a bottom end thereof;
two conductive media which are located in the two electrode passages including upper ends soldered to the two electrodes of the LED chip to form electric connection and lower ends extended outside the bottom of the socket;
a holder holding the socket and including an annular retaining portion at an inner bottom end to butt the base and a second thread portion formed on a circumferential inner wall; and
a lens including a third thread portion extended from a bottom end thereof to engage with the second thread portion by screwing.

2. The LED lamp electrode structure of claim 1, wherein the two conductive media are conductive wires each being coupled by a waterproof bolt.

3. The LED lamp electrode structure of claim 1 further including a fastening nut screwing with the first thread portion.

4. The LED lamp electrode structure of claim 3 further including a holding plate with an opening running through the bottom of the socket to butt the holder.

5. The LED lamp electrode structure of claim 1, wherein the lens includes optical textures.

6. The LED lamp electrode structure of claim 1 further including radiation fins screwing with the first thread portion.

7. The LED lamp electrode structure of claim 6 further including a holding plate and a lamp cap, the holding plate including an opening and the lamp cap including a hole that run through the bottom of the socket to butt the holder.

8. The LED lamp electrode structure of claim 1, wherein the socket and the holder are made of high thermal conductive metal.

9. The LED lamp electrode structure of claim 1 further including a lamp cup which includes a fourth thread portion extended from a bottom end thereof to screw with the second thread portion and a fifth thread portion extended from a top end thereof to screw with the third thread portion of the lens, the lamp cup including optical textures on an inner wall thereof.

10. An LED lamp electrode structure, comprising:
an LED chip including two electrodes;
a socket including a base which includes a clamp portion at the top, two electrode passages running through the socket and a waterproof washer coupled thereon, the clamp portion including two clamp heads on an upper side to clamp the LED chip, the socket further including a first thread portion extended from a bottom end thereof;
two conductive media which are located in the two electrode passages including upper ends soldered to the two electrodes of the LED chip to form electric connection and lower ends extended outside the bottom of the socket to form two electrode contacts, one electrode contact being located in the center of the bottom of the socket and another electrode contact being located near the center of the bottom of the socket;
a holder holding the socket and including an annular retaining portion at an inner bottom end to butt the base and a second thread portion formed on a circumferential inner wall; and
a lens including a third thread portion extended from a bottom end thereof to engage with the second thread portion by screwing.

11. The LED lamp electrode structure of claim 10 further including a fastening nut screwing with the first thread portion.

12. The LED lamp electrode structure of claim 11 further including a holding plate with an opening running through the bottom of the socket to butt the holder.

13. The LED lamp electrode structure of claim 10, wherein the two conductive media are conductive wires each being coupled by a waterproof bolt.

14. The LED lamp electrode structure of claim 10, wherein the lens includes optical textures.

15. The LED lamp electrode structure of claim 10 further including radiation fins screwing with the first thread portion.

16. The LED lamp electrode structure of claim 15 further including a holding plate and a lamp cap, the holding plate including an opening and the lamp cap including a hole that run through the bottom of the socket to butt the holder.

17. The LED lamp electrode structure of claim 10, wherein the socket and the holder are made of high thermal conductive metal.

18. The LED lamp electrode structure of claim 10 further including a lamp cup which includes a fourth thread portion extended from a bottom end thereof to screw with the second thread portion and a fifth thread portion extended from a top end thereof to screw with the third thread portion of the lens, the lamp cup including optical textures on an inner wall thereof.
